(19) United States
(12) Patent Application Publication
(10) Pub. No.: US 2005/0140628 A1
(43) Pub. Date: Jun. 30, 2005

(54) Driving system for a liquid crystal display

(75) Inventors: Eui Yeol Oh, Yongin-si (KR); Ki Duk Kim, Goonpo-si (KR); Chul Sang Jang, Seongnam-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 10/955,011

(22) Filed: Sep. 30, 2004

(30) Foreign Application Priority Data
Dec. 29, 2003 (KR) P2003-99347

(51) Int. Cl. G09G 3/36

(52) U.S. Cl. 345/89

(57) ABSTRACT

A driving system for a liquid crystal display includes an analog driving circuit unit, a digital analog converter and a digital interface unit. The digital analog converter supplies an analog voltage for operating the analog driving circuit unit. The digital interface unit supplies a digital signal to the digital analog converter. The analog driving circuit units, the digital analog converter and the digital interface unit may be mounted on a single chip.

### PRIORITY CLAIM

This application claims the benefit of Korean Application No. 2003-99347, filed on Dec. 29, 2003. The disclosure of the above application is incorporated herein by reference.

### BACKGROUND

1. Technical Field

The invention relates to a liquid crystal display (LCD), and more particularly, to a driving system for an LCD in which an analog driving circuit unit is controlled in a programmable manner.

2. Related Art

LCDs are used for a large number of information processing devices such as computers because of slim and lightweight designs and good performances as display devices. As demands for LCDs increase, it is required to improve an image quality of LCDs such as brightness, contrast ratio, etc.

FIG. 1 illustrates a block diagram of an LCD module 1. As shown in FIG. 1, the LCD module 1 includes a digital video card 10, a controller 11, a gate driver 12, a data driver 13 and a liquid crystal panel 20. The digital video card 10 converts analog image signals into digital image signals. The controller 11 receives digital image signals from the digital video card 10 and controls the gate driver 12 and the data driver 13. The gate driver 12 turns on/off a thin film transistor (“TFT”), which is a switching element of a liquid crystal panel 20 by receiving scanning signals controlled by the controller 11. The LCD module 1 further includes a gamma circuit 15, which provides to the data driver 13 gamma voltages to change transmittance of liquid crystal used in the liquid crystal panel 20. The data driver 13 provides gamma voltages corresponding to digital image signals from the controller 11 to a pixel area of the liquid crystal panel 20. The LCD module 1 also includes a Vcom circuit 40 and an inverter controller 50, which will be described in detail below in connection with FIG. 2.

The LCD module 1 operates as follows. Digital image signals from the digital video card 10 are first transmitted to the controller 11. The controller 11 synchronizes the digital image signals and provides synchronized signals to the data driver 13. In addition, the controller 11 delivers to the gate driver 12 scanning signals for turning on/off the TFTs connected with the data lines. The data driver 13 converts digital image signals delivered from the controller 11 to analog image signals and sequentially transfers the analog signals to a plurality of data lines formed on the liquid crystal panel 20. When the digital image signals are converted into the analog image signals, the gamma circuit 15 provides a gamma voltage for controlling the transmittance of the liquid crystal. Specifically, the gamma voltage provided by the gamma circuit 15 is divided into a plurality of tone voltages by resistor circuits disposed inside of the gamma circuit 15. Each divided tone voltage corresponds to each digital image signal and is eventually outputted to the respective data line as analog image signals. Meanwhile, the gate driver 12 turns on/off the TFT by sequentially providing scanning signals to a plurality of gate lines formed on the liquid crystal panel 20. Accordingly, the analog image signals delivered from the data lines are transferred to a respective pixel area.

FIG. 2 is a circuit diagram showing an analog driving circuit unit 31 for an LCD according to the related art. Referring to FIG. 2, the analog driving circuit 31 includes a gamma circuit 15, a Vcom circuit 40 and an inverter controller 50. The Vcom circuit 40 provides a common reference voltage to a liquid crystal panel and an inverter controller 50 controls an inverter, which controls a backlight. The gamma circuit 15, the Vcom circuit 40 and the inverter controller 50 are configured separately from one another as shown in FIG. 2.

The gamma circuit 15 has a plurality of resistors R1, R2, . . . Rn, which are connected in series and divide a voltage. Each resistor R1, R2, . . . Rn is connected to a buffer 35 which includes an operational amplifier (“OP Amp”), respectively. Another resistors R11 . . . Rnn are connected to an output terminal of the buffer so that the previously divided voltage may be divided again. The respective gamma voltage is outputted therefrom.

The Vcom circuit 40 has the following construction. A plurality of resistors R101, R102 . . . and a variable resistor VR1 are connected in series and divide a voltage. Each divided voltage is transferred to a buffer 45 including an OP Amp. An output terminal of the buffer 45 outputs a Vcom voltage which is appropriate for a liquid crystal panel. The inverter controller 50 receives an analog voltage and converts the voltage by using resistors disposed therein (not shown). Consequently, the inverter controller 50 generates a control signal for driving an inverter of an LCD.

The analog driving circuits 31 results in a large size and high manufacturing costs because each driving circuit needs to be separately manufactured. Further, because an output voltage is generated after the analog voltage is divided by multiple resistors, such voltage is not generated in a programmable manner. Specifically, once resistances of multiple resistors are determined, it is not possible to change output voltages generated by multiple resistors. Consequently, the analog driving circuits 31 cannot be controlled by a digital processor that processes digital image signals. There is a need for a driving circuit for an LCD that overcomes the foregoing drawbacks of the related art.

### SUMMARY

A driving system for an LCD is provided that includes an analog driving circuit unit, a digital analog converter and a digital interface unit. The digital analog converter supplies an analog voltage that operates the analog driving circuit unit. The digital interface unit supplies a digital signal to the digital analog converter. The analog driving circuit unit, the digital analog converter and the digital interface unit may be formed on a single chip. In one embodiment, an analog driving circuit unit includes a gamma circuit, a common circuit, and an inverter controller.

A driving system for an LCD can improve a display quality by integrating the analog driving circuit unit with other circuit elements and controlling it with a control signal. A digital image signal processor and/or an EEPROM (Electronically Erasable Programmable Read Only Memory) generate and provide such control signal. Accordingly, the driving circuit can control the analog driving circuit unit in a programmable manner.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram showing a related art LCD module;

FIG. 2 is a circuit diagram showing an analog driving circuit unit according to the related art; and

FIG. 3 is a block diagram showing one embodiment of an analog driving circuit unit.

### DETAILED DESCRIPTION OF THE EMBODIMENTS

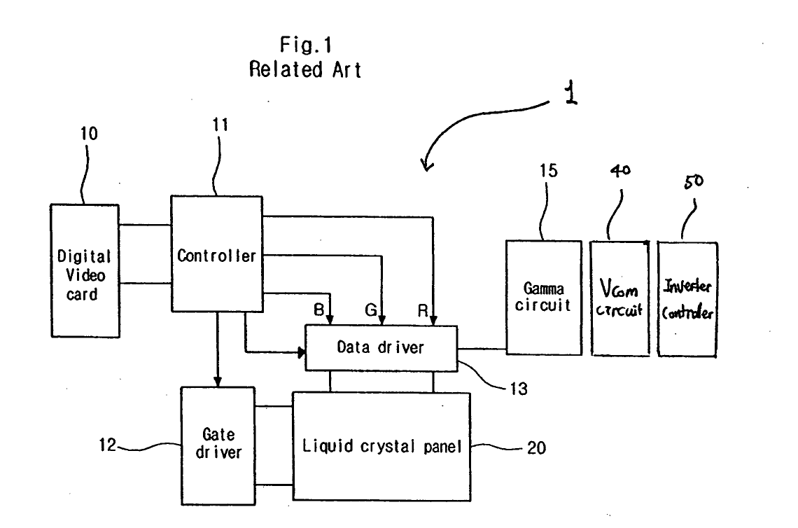

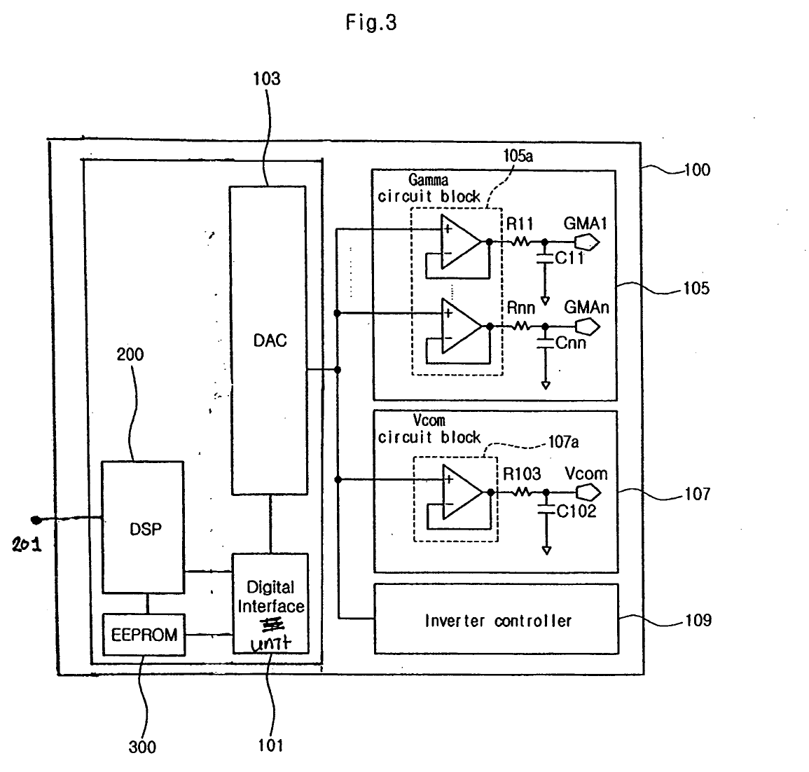

FIG. 3 shows one embodiment of an analog driving circuit unit 100 for an LCD module. An LCD module including the analog driving circuit unit 100 has structures similar to that of the LCD module 1 as shown in FIG. 1. Specifically, the LCD module includes a digital video card, a controller, a gate driver, a data driver and a liquid crystal panel that may have structures and operations similar to those of the digital video card 10, the controller 11, the gate driver 12, the data driver 13 and the liquid crystal panel 20. Accordingly, detailed descriptions thereon are omitted here.

Referring to FIG. 3, the analog driving circuit unit 100 includes a gamma circuit 105, a Vcom circuit 107, an inverter controller 109, a digital/analog converter unit 103 and a digital interface unit 101. The Vcom circuit 105 provides a common reference voltage on a liquid crystal panel and the inverter controller 109 generates a control signal for driving an inverter. A digital/analog converter (“DAC”) unit 103 provides analog signals to the gamma circuit 105, and at least one of the Vcom circuit 107 and the inverter controller 109, respectively. More preferably, the DAC unit 103 provides analog signals to the gamma circuit 105, the Vcom circuit 107 and the inverter controller 109. The digital interface unit 101 provides a digital control signal to the DAC unit 103. The analog driving circuit unit 100 may integrate the gamma circuit 105, the Vcom circuit 107 and the inverter controller 109 on a single chip. The DAC unit 103, the digital interface unit 101, a digital signal processor (“DSP”) 200 and EEPROM 300 may be also on a single chip as shown in FIG. 3.

In operation, the DSP 200 receives a digital image signal from an input terminal 201. The input terminal 201 of the DSP 200 may be disposed between a digital video card such as the digital video card 10 and a controller such as the controller 11. Alternatively, the input terminal 201 may be disposed between a controller such as the controller 11 and a data driver such as the data driver 13. The DSP 200 analyzes the digital image signal per frame and determines whether at least one image quality, for example, a brightness or a contrast ratio, needs to be adjusted. The EEPROM 300 stores various control signals as default values. The DSP 200 fetches a control signal that adjusts the image quality from the EEPROM 300 and provides it to the digital interface unit 101. Alternatively, if the EEPROM 300 does not store a necessary control signal, the DSP 200 may generate such control signal. Then, the control signal is transmitted to the DAC unit 103 through the digital interface unit 101. The DAC unit 103 converts the control signal into an analog signal and directly transmits it to the gamma circuit 105, the Vcom circuit 107 and/or the inverter controller 109.

An example of the above operation is described. The DSP 200 analyzes an image data at frame 1. The DSP 200 determines that a brightness of the image data should be adjusted because the image data is too dark. The DSP 200 verifies whether the EEPROM 300 stores a control signal that increases a brightness of a backlight. If the EEPROM 300 stores the control signal, the control signal is selected and transmitted to a digital interface unit 101. If the EEPROM 300 does not store the control signal, the DSP 200 may generate a necessary control signal. The control signal from the EEPROM 300 is provided to the DAC 103 via the digital interface unit 101. Subsequently, the DAC unit 103 converts this signal into an analog voltage and provides the same to the inverter controller 109. Based on the received analog voltage, the inverter controller 109 controls an inverter that drives a backlight of a liquid crystal panel such as the liquid crystal panel 20. The brightness of the backlight of the liquid crystal panel is increased and an image data at frame 2, which is brighter than the image data at the frame 1, is displayed.

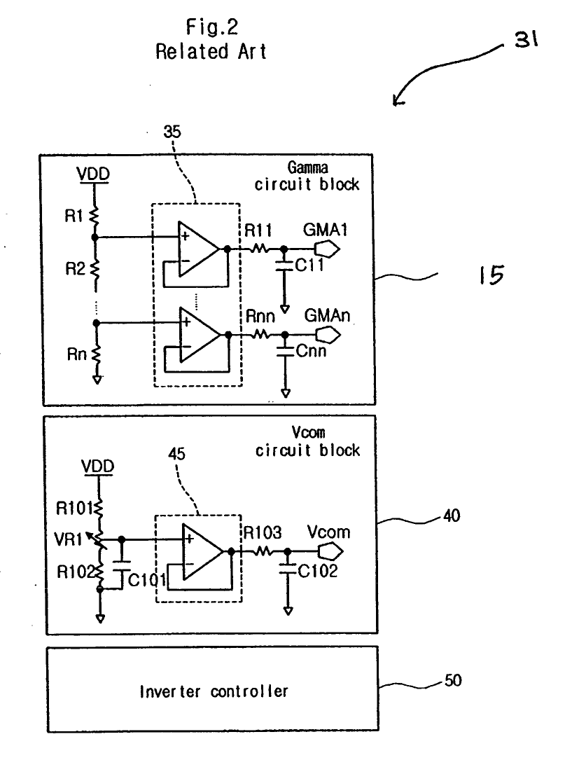

Alternatively, as a result of analyzing the image data, the DSP 200 may determine that a contrast ratio is required to be adjusted. Then, either the DSP 200 or the EEPROM 300 provides a control signal for changing a gamma voltage to the DAC unit 103 through the digital interface unit 101. The DAC unit 103 converts this control signal into an analog signal and provides the same to the gamma circuit 105. The gamma circuit 105 provides the analog signal to a liquid crystal panel through a data driver such as the data driver 13. The analog voltage provided to the gamma circuit 105 is not divided by multiple resistors (as shown in FIG. 2) but is controlled by the DSP 200. As such, the gamma circuit 105 does not need multiple resistors. The construction of the gamma circuit 105 may require a buffer 105a and an output terminal. Alternatively, or additionally, It is possible to omit the buffer 105a. Accordingly, a circuit construction is substantially simplified.

The Vcom circuit 107 may be configured in a manner that the gamma circuit 105 is configured as described above. Specifically, the DSP 200 analyzes an image data and determines that a reference voltage needs to be adjusted. A Vcom control signal in a digital signal format is provided to the DAC unit 103. The DAC unit 103 converts the digital signal into an analog voltage and provides it to the Vcom circuit 107. The Vcom circuit 107 provides the analog voltage to a liquid crystal panel. Because the Vcom circuit 107 does not require circuit elements such as resistors and variable resistors, a simple construction is possible. The analog voltage provided to the Vcom circuit 107 is controlled by the control signal provided from the EEPROM 300 or generated from the DSP 200. Analog voltage is transmitted through a buffer 107a of the Vcom circuit 107, but the buffer 107a may be omitted.

The DSP 200 of the analog driving circuit unit 100 consistently analyzes a displayed image and preferably provides control signals to the gamma circuit 105, the Vcom circuit 107 and/or the inverter controller 109. As a result, a display quality is optimized. As a result, analog circuits are controlled by the DSP 200 in a programmable manner. Furthermore, the analog circuits can be arranged to be integrated on a single chip. This arrangement facilitates control of the analog circuits by the DSP 200 and reduces manufacturing costs and device sizes.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A driving circuit for a liquid crystal display that displays an image data, comprising:
a digital signal processor analyzing the image data and determining whether at least one image quality of an analyzed image data needs to be adjusted;
an EEPROM connected to the digital signal processor and storing a plurality of pre-programmed digital control signals, wherein the plurality of digital control signals are configured to adjust the image quality of the analyzed image data;
a digital analog converter unit receiving a digital control signal selected from the plurality of digital control signals from the EEPROM and converting the digital control signal into an analog voltage; and,
an analog driving circuit unit receiving the analog voltage from the digital analog converter and providing the analog voltage to a gamma circuit and to at least one of a common circuit and an inverter controller, wherein the gamma circuit provides a gamma voltage to the liquid crystal display and the common circuit provides a common reference voltage to the liquid crystal display and the inverter controller generates a control signal for driving an inverter.

2. The driving circuit of claim 1, wherein the analog driving circuit unit provides the analog voltage to a gamma circuit, a common circuit and an inverter controller.

3. The driving circuit of claim 1, wherein the digital signal processor generates a digital control signal to adjust the at least one image quality if the EEPROM does not store the digital control signal.

4. The driving circuit according to claim 1, wherein the image quality includes a brightness.

5. The driving circuit according to claim 1, wherein the image quality includes a contrast ratio.

6. The driving circuit according to claim 2, wherein the gamma circuit, the common circuit and the inverter controller are mounted on a single chip.

7. The driving circuit according to claim 1, wherein the digital signal processor, is the EEPROM, the digital analog converter and the digital interface unit are mounted on a single chip.

8. The driving circuit according to claim 6, wherein the digital signal processor, the EEPROM, the digital analog converter and the digital interface unit are mounted on a single chip.

9. The driving circuit according to claim 1, wherein the analog voltage is inputted to a buffer of the gamma circuit.

10. The driving circuit according to claim 1, wherein the analog voltage is inputted to a buffer of the common circuit.

11. The driving circuit according to claim 1, wherein the analog voltage is inputted to a buffer of the inverter controller.

12. A method for driving a liquid crystal display that displays an image data, comprising:
analyzing the image data and determining whether at least one image quality of the image data needs to be adjusted by a digital signal processor;
storing a plurality of preprogrammed control signals at an EEPROM;
selecting from the EEPROM a control signal that is necessary to adjust the image quality;
transmitting the control signal to a digital analog converter via a digital interface unit;
converting the control signal to an analog voltage by the digital analog converter; and,
providing the analog voltage to a common circuit that supplies a common reference voltage to the liquid crystal display.

13. The method of claim 12, further comprising:
verifying whether the EEPROM stores the control signal that is necessary to adjust the image quality; and,
generating the control signal by the digital signal processor upon the verification that the EEPROM does not store the control signal.

14. The method of claim 12, further comprising:
providing the analog voltage to an inverter controller that generates a control signal to drive an inverter.

15. The method of claim 12, further comprising:
mounting the digital signal processor, the EEPROM, the digital analog converter and the common circuit on a single chip.

16. The method of claim 14, further comprising:
mounting the digital signal processor, the EEPROM, the digital analog converter, the common circuit and the inverter controller on a single chip.

17. A method for driving a liquid crystal display that displays an image data, comprising:
analyzing the image data and determining whether at least one image quality of the image data needs to be adjusted by a digital signal processor;
storing a plurality of preprogrammed control signals at an EEPROM;
selecting from the EEPROM a control signal that is necessary to adjust the image quality;
transmitting the control signal to a digital analog converter via a digital interface unit;
converting the control signal to an analog voltage by the digital analog converter; and, providing the analog voltage to an inverter controller that generates a control signal to drive an inverter.

18. The method of claim 17, further comprising:
verifying whether the EEPROM stores the control signal that is necessary to adjust the image quality; and, generating the control signal by the digital signal processor upon the verification that the EEPROM does not store the control signal.

19. The method of claim 17, further comprising:
mounting the digital signal processor, the EEPROM, the digital analog converter and the inverter controller on a single chip.

20. A method for driving a liquid crystal display that displays an image data, comprising:
analyzing the image data and determining whether at least one image quality of the image data needs to be adjusted by a digital signal processor;
storing a plurality of preprogrammed control signals at an EEPROM;
selecting from the EEPROM a control signal that is necessary to adjust the image quality;
transmitting the control signal to a digital analog converter via a digital interface unit;
converting the control signal to an analog voltage by the digital analog converter; and,
providing the analog voltage to a gamma circuit and at least one of a common circuit and an inverter controller, wherein the gamma circuit provides a gamma voltage to the liquid crystal display and the common circuit provides a common reference voltage to the liquid crystal display and the inverter controller generates a control signal for driving an inverter.

21. The method of claim 20, wherein the step of providing the analog voltage further comprises providing the analog voltage to the gamma circuit, the common circuit and the inverter controller.

22. The method of claim 20, further comprising:
verifying whether the EEPROM stores the control signal that is necessary to adjust the image quality; and,
generating the control signal by the digital signal processor upon the verification that the EEPROM does not store the control signal.

23. The method of claim 21, further comprising:
mounting the gamma circuit, the common circuit and the inverter controller on a single chip.

24. The method of claim 23, further comprising:
mounting the digital signal processor, the EEPROM, and the digital analog converter on a single chip.
